(19) United States
(12) Patent Application Publication
(10) Pub. No.: US 2025/0259150 A1
(43) Pub. Date: Aug. 14, 2025

(54) Tiny House App

(71) Applicant: Ian Guyton, Lancaster, CA (US)

(72) Inventor: Ian Guyton, Lancaster, CA (US)

(21) Appl. No.: 18/436,368

(22) Filed: Feb. 8, 2024

(51) Int. Cl. G06Q 10/30; G06Q 50/16

(52) U.S. Cl. CPC G06Q 10/30; G06Q 50/16

(57) ABSTRACT

Because of the momentum of the minimalist movement, in addition to the homeless problem and climate change, this “Tiny House App” is a possible solution.

### CROSS-REFERENCE TO RELATED APPLICATIONS

N/A.

### STATEMENT REGARDING FEDERALLY SPONSORED RESEARCH OR DEVELOPMENT

N/A yet.

### THE NAMES OF THE PARTIES TO A JOINT RESEARCH AGREEMENT

N/A yet.

### INCORPORATION-BY-REFERENCE OF MATERIAL SUBMITTED ON A COMPACT DISC OR AS A TEXT FILE VIA THE OFFICE ELECTRONIC FILING SYSTEM (EFS-WEB

N/A yet.

### STATEMENT REGARDING PRIOR DISCLOSURES BY THE INVENTOR OR A JOINT INVENTOR

Disclosed idea to thoughtstopaper.com on around Sep. 1, 2021, patent pending expired on Sep. 1, 2022.

### BACKGROUND OF THE INVENTION

Greenhouse gasses, in the form of carbon emissions are one of the biggest and direct contributors to pollution and climate change issues in the world. Automobiles are notably one of the largest contributors of greenhouse gas emissions today, accounting for about 29% of total green house gas emissions as of 2021. Newer cars being built today have incorporated significant advancements in an effort to mitigate their carbon emissions, but there are still millions of older, used cars in use around the world. The present invention aims to reduce the consequences of carbon emissions through allowing users to effectively trade in their used, gas-guzzling and carbon emitting automobiles to builders to turn them into tiny houses, which will reduce the climate impact significantly.

### FIELD OF THE INVENTION

The present invention relates generally to automobiles. More specifically, a method for a software application in which users can use to convert their used automobiles into tiny houses.

### DESCRIPTION OF RELATED ART INCLUDING INFORMATION DISCLOSED UNDER 37 CFR 1.97 AND 1.98

N/A.

### BRIEF SUMMARY OF THE INVENTION

Simply said, I see a real estate opportunity in reducing homelessness and/by repurposing the gas-guzzling cars that pollute the atmosphere with carbon emissions by using this “Tiny House App.”

### BRIEF DESCRIPTION OF THE SEVERAL VIEWS OF THE DRAWING(S)

FIG. 1 shows cars in a driveway that can be photographed in detail and uploaded to the tiny house app to give house builders a visual of what they would be working with.

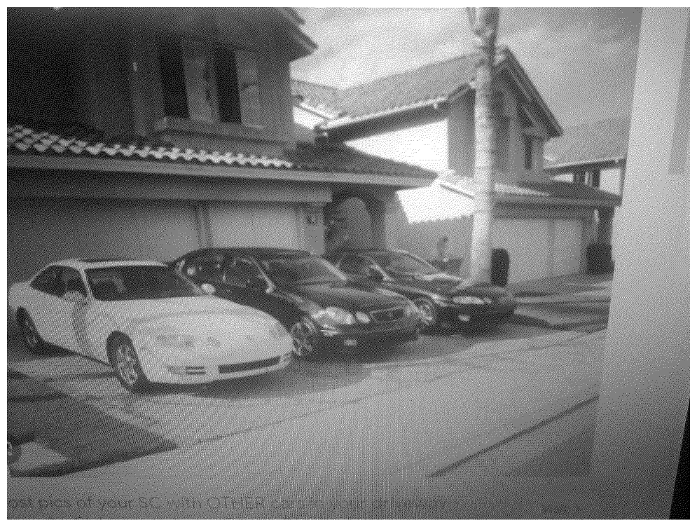

FIG. 2 shows a car being towed away to supply material for the house to be built.

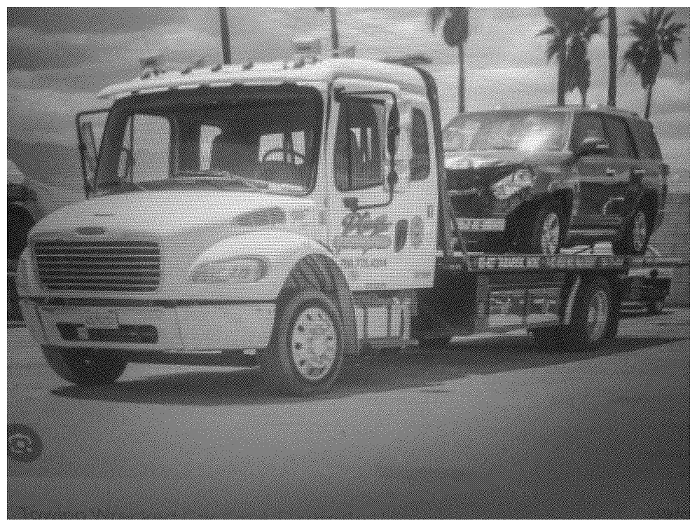

FIG. 3 shows the tiny house that was potentially built from the car(s) as well as other material that was necessary.

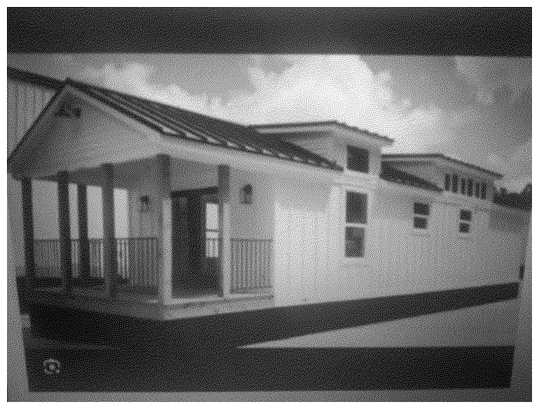

### DETAILED DESCRIPTION OF THE INVENTION

The present invention, herein referred to as “Tiny House App”, is a user-friendly app that lets a person arrange to send their used, gas-guzzling automobiles to a place that builds a tiny house from their used gas-guzzling automobile material. The user with this app can upload detailed pictures of their used gas-guzzling automobiles to give the tiny house builders a visual of what they would be working with. In turn, the house builders can convert their automobiles into tiny houses.

1. Designed from photographs of cars or multiple cars uploaded to the app.

2. Clients may see multiple tiny house designs on the app before choosing which one to be built.

3. Non-car material for building a tiny house can be added.
